(19) United States
(12) Patent Application Publication
(10) Pub. No.: US 2004/0127202 A1
(43) Pub. Date: Jul. 1, 2004

(54) Method for remotely updating software for radio port

(76) Inventors: Yi-Wen Shih, Taipei City (TW); Hsin-Neng Hsu, Tao-Yuan Hsien (TW); Hsi-Kun Chen, Tai-Chung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,250

(22) Filed: Dec. 31, 2002

(51) Int. Cl. H04M 3/00

(52) U.S. Cl. 455/418; 455/419

(57) ABSTRACT

A method of remotely sending updated radio port software from a radio port control unit (RPCU) to a radio port (RP) and storing the RP software in a memory of the RP. The memory includes first and second program code areas for storing first and second versions of the RP software. The method includes reading an indicator to determine which of the first or second program code areas is used for storing a current version of the RP software, running the current version of the RP software from either the first or second program code areas, storing an updated version of the RP software in the first or second program area that is not used for storing the current version of the RP software, and changing the indicator to indicate which of the first or second program code areas is used for storing the updated version of the RP software.

### BACKGROUND OF INVENTION

1. Field of the Invention

The present invention relates to a method for updating software in a radio port (RP), and more specifically, to a method of remotely sending updated RP software from an RP control unit (RPCU) to an RP.

2. Description of the Prior Art

In a cellular phone network, many radio ports (RPs) are controlled by one radio port control unit (RPCU). Please refer to FIG. 1. FIG. 1 is a block diagram of a cellular phone network containing an RPCU 20 and a plurality of RPs 10 according to the prior art. Each RP 10 can communicate with the RPCU 20 through a wired connection.

Please refer to FIG. 2. FIG. 2 is a functional block diagram showing a memory structure of the RP 10. Each RP 10 contains a random-access memory (RAM) 12, which is used as temporary memory during operation of the RP 10, and a flash memory 14, which is used for storing operating software of the RP 10.

Unfortunately, with the prior art, each time the operating software of the RP 10 is to be changed or updated, a technician must be called over to the site of the RP 10 in order to replace the flash memory 14 of the RP 10. To replace the flash memory 14, first the RP 10 must be shut down, which disrupts the ability of the RP 10 to provide service. Next, the old flash memory 14 is replaced with a new flash memory 14. Then the RP 10 is restarted, and service is resumed. This prior art method of updating operating software is time consuming, requires the expense of having a technician make a service call, and requires temporarily halting service of the RP 10.

As a solution to this, in U.S. Pat. No. 6,275,694 B1 entitled “Method for remotely updating software code for personal handy phone system equipment”, Yoshida et al. disclose a method for updating the operating software of the RP 10, the method being included herein by reference. Please refer to FIG. 3. FIG. 3 contains a flowchart illustrating a method for remotely updating operating software of the RP 10 according to the prior art.

Step 52: Start the process of remotely updating operating software;

Step 54: The RPCU 20 transmits a preparatory control signal to the RP 10;

Step 56: The RP 10 receives and recognizes the preparatory control signal;

Step 58:

The RP 10 determines if the preparatory control signal is valid; if so, go to step 60; if not, go to step 68;

Step 60: The RP 10 transmits a verification signal to the RPCU 20;

Step 62: The RPCU 20 receives and recognizes the verification signal;

Step 64: The RPCU 20 transmits updated operating software to the RP 10;

Step 66:

The RP 10 receives the updated operating software and stores it in the flash memory 14; and

Step 68: End.

A problem with this prior art method of remotely updating the operating software of the RP 10 is that there is no checking mechanism used for ensuring that the updated operating software was correctly downloaded. In step 64, the RPCU 20 transmits the updated operating software to the RP 10, and in step 66, the RP 10 immediately stores the updated operating software in the flash memory 14. If noise was present during the downloading process, or if there was a temporary problem with the communication between the RPCU 20 and the RP 10, the updated operating software could be corrupted. Thus, there is no guarantee that the download was successful. Furthermore, while the contents of the flash memory 14 are being updated, the RP 10 is not able to provide service since the operating software cannot be executed while it is being updated.

### SUMMARY OF INVENTION

It is therefore a primary objective of the claimed invention to provide a method of remotely sending updated RP software from an RPCU to an RP in order to solve the above-mentioned problems.

According to the claimed invention, a method of remotely sending updated radio port software from a radio port control unit (RPCU) to a radio port (RP) and storing the RP software in a memory of the RP is introduced. The memory includes a first program code area for storing a first version of the RP software, a second program code area for storing a second version of the RP software, and an internal parameter area containing an indicator for indicating which of the first and second program code areas stores current RP software to be executed by the RP. The method includes reading the indicator in the internal parameter area to determine which of the first or second program code areas is used for storing a current version of the RP software, running the current version of the RP software from either the first or second program code areas of the memory, storing an updated version of the RP software in the first or second program area that is not used for storing the current version of the RP software, and changing the indicator in the internal parameter area to indicate which of the first or second program code areas is used for storing the updated version of the RP software.

It is an advantage of the claimed invention that the RP verifies that the checksum calculated by the RPCU is equal to the checksum calculated by the RP for ensuring the accuracy of the updated RP software downloaded from the RPCU.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a cellular phone network containing a radio port control unit (RPCU) and a plurality of radio ports (RPs) according to the prior art.

FIG. 2 is a functional block diagram showing a memory structure of the RP.

FIG. 3 contains a flowchart illustrating a method for remotely updating operating software of the RP according to the prior art.

FIG. 4 shows a structure of a flash memory used in an RP according to the present invention.

FIG. 5A and FIG. 5B contain a flow chart illustrating actions taken by the RP to download updated operating software from the RPCU.

FIG. 6 contains a flow chart illustrating actions taken by the RPCU to transmit updated operating software to the RP.

FIG. 7 is a message sequence chart illustrating communication between the RP and the RPCU during an update procedure.

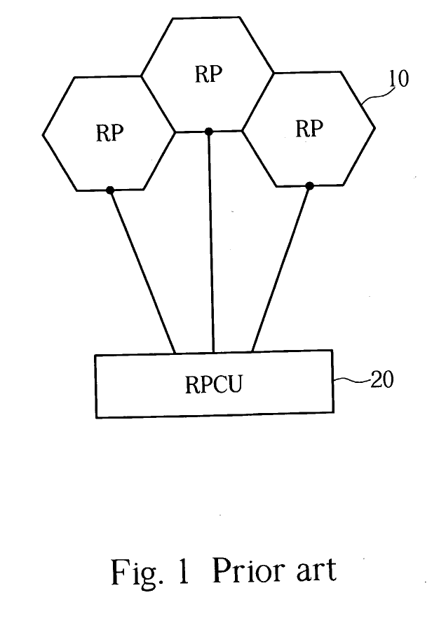

### DETAILED DESCRIPTION

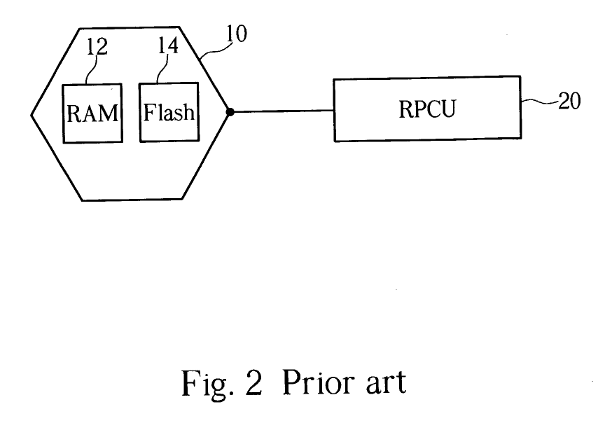

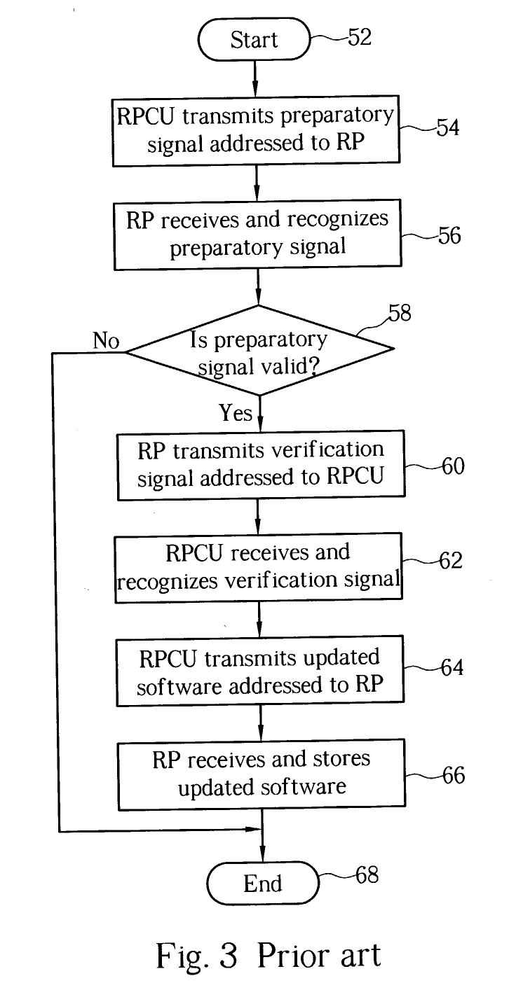

The RP 10, the RPCU 20, the RAM 12, and the flash memory 14 used in the present invention are all identical to the prior art components shown in FIG. 2. Therefore, the same reference numbers will be used to describe the present invention. The present invention improves upon the method shown in FIG. 3 by dividing the flash memory 14 into sections.

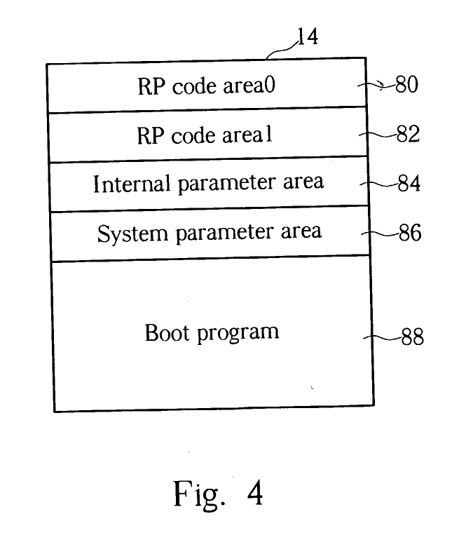

Please refer to FIG. 4. FIG. 4 shows a structure of the flash memory 14 used in the RP 10 according to the present invention. The flash memory 14 contains two program code areas 80 and 82 for storing two versions of the operating software, an internal parameter area 84 for storing program parameters used by the operating software, a system parameter area 86 for storing general operational parameters of the RP 10 such as channel and power characteristics, and a boot program area 88 for storing a main booting program of the RP 10.

The internal parameter area 84 can store an indicator containing a “0” or a “1”, which respectively correspond to the two program code areas 80 and 82. If the indicator in the internal parameter area 84 contains a “0”, that means that the operating software contained in the program code area 80 is being used to operate the RP 10. On the other hand, if the indicator in the internal parameter area 84 contains a “1”, that means that the operating software contained in the program code area 82 is being used to operate the RP 10. The significance of having two program code areas 80 and 82 is that while one of the program code areas 80 and 82 is holding the operating software used to operate the RP 10, the other one of the program code areas 80 and 82 can be used to store updated operating software downloaded from the RPCU 20. This allows the updated operating software to be downloaded while the RP 10 continues to provide service.

In order for the RP 10 to successfully receive updated operating software from the RPCU 20, a series of actions is necessary by both the RP 10 and the RPCU 20. First of all, the RPCU 20 must divide the updated operating software into N packets. The RPCU 20 calculates a checksum of the updated operating software and places this checksum into packet #0, which is used for storing the checksum and indicating how many data packets will be sent during the update process. The rest of the packets, namely packet #1 through packet #N−1 are then used for transmitting sequential pieces of the updated operating software to the RP 10. For example, if the updated operating software contains 80 kb (80*1024 bytes) of data, and each packet store 64 bytes, there will be a total of 1281 packets (81,920/64+1=1 281) labeled as packet #0 through packet #1281. These 1281 packets include packet #0, which holds the checksum, and 1280 data packets that are used to transmit the updated operating software.

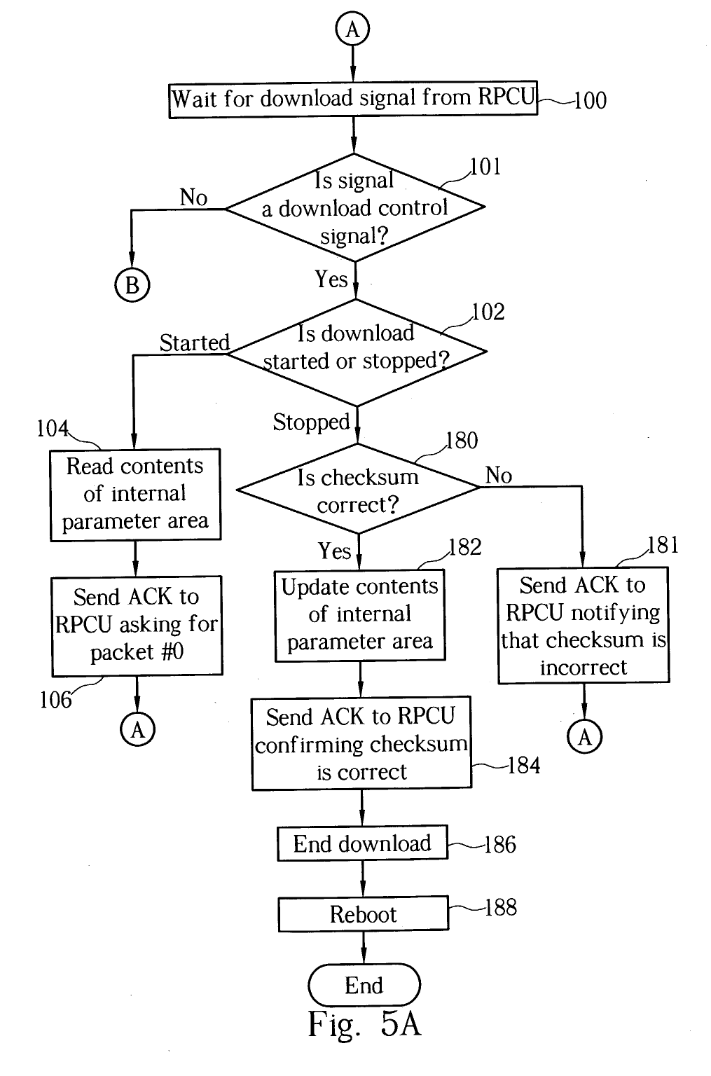

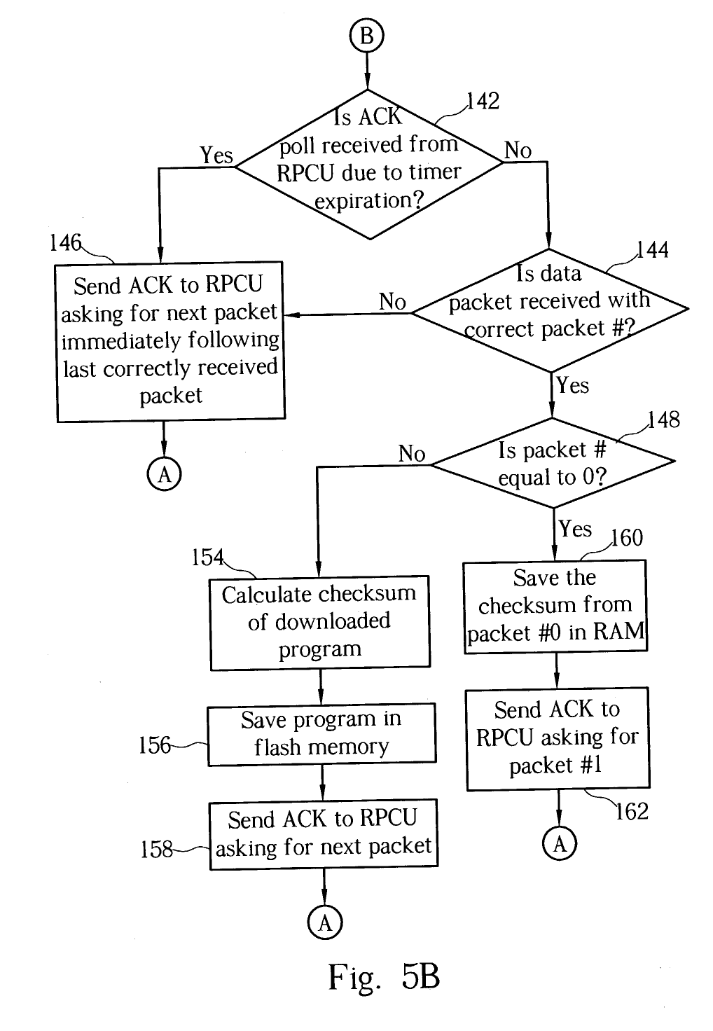

Please refer to FIG. 5A and FIG. 5B. FIG. 5A and FIG. 5B contain a flow chart illustrating actions taken by the RP 10 to download updated operating software from the RPCU 20. Continuation markers “A” and “B” are used for conveniently showing connection between FIG. 5A and FIG. 5B.

Step 100: Wait for a download signal from the RPCU 20;

Step 101:

Download control signals contain two bytes, with the first byte containing a value of “30” and the second byte containing an indicator. Determine if the download signal is a download control signal used for starting or stopping the download procedure; if so, go to step 102; if not, another type of signal was sent, go to step 142;

Step 102:

Check the indicator of the download control signal to determine if the download procedure has been started or stopped. If the RPCU 20 is sending the download control signal to the RP 10, an indicator of “01” represents that the download procedure is started, and an indicator of “00” represents that the download procedure is stopped. If the procedure has been started, go to step 104; if the procedure has been stopped, go to step 180;

Step 104:

Read the contents of the indicator in the internal parameter area 84 of the flash memory 14 to determine which of the program code areas 80 and 82 is being used to store the current version of the operating software and which of the program code areas 80 and 82 is available to store an updated version of the operating software;

Step 106:

Send an acknowledgement signal to the RPCU 20 stating that the download control signal was received, and asking the RPCU 20 for packet #0 of the updated operating software; go to step 100;

Step 142:

When the RPCU sends the RP a packet, a timer associated with that packet is started. If the RPCU does not receive acknowledgement of the packet before the timer expires, the RPCU will send an acknowledgement poll to the RP. Determine if an acknowledgement poll is received from the RPCU 20, asking the RP 10 to acknowledge a previous transmission from the RPCU 20 to the RP 10; if so, go to step 146; if not, go to step 144;

Step 144:

Determine if a data packet was received with the correct packet number; if so, go to step 148, if not; go to step 146;

Step 146:

Since the data packet did not have the correct packet number on it, send an acknowledgement signal to the RPCU 20 requesting that the RPCU 20 send the packet immediately following the last correctly received packet (For example, if the last correctly received packet was packet #1, and the current packet is not packet #2, the RP 10 requests that the RPCU 20 send packet #2. If packet #0 was expected, the RP 10 requests that the RPCU 20 send packet #0); go to step 100;

Step 148:

Determine if the packet number is equal to packet #0; if so, go to step 160; if not, go to step 154;

Step 154:

Calculate a checksum of the packet that was just downloaded, and add this checksum value to the checksum value of packets previously downloaded;

Step 156:

Save the packet of the updated operating software into the program code area 80 or 82 of the flash memory 14 that is available to store the updated version of the operating software;

Step 158:

Send an acknowledgement to the RPCU 20 stating that the current packet was received and asking for the next data packet; go to step 100;

Step 160:

Since the current packet is packet #0, extract the checksum contained in packet #0 and store the checksum in RAM 12;

Step 162:

Send an acknowledgement to the RPCU 20 stating that packet #0 was received and asking for packet #1; go to step 100;

Step 180:

Compare the checksum of the downloaded operating software calculated by the RP 10 with the checksum received from the RPCU 20 in packet #0; if the checksums match, go to step 182; if the checksums do not match, go to step 181;

Step 181:

Send an acknowledgement to the RPCU 20 to notify the RPCU 20 that checksum is incorrect and the download procedure will have to be repeated; go to step 100;

Step 182:

Update the indicator in the internal parameter area 84 such that the indicator states that the program code area 80 or 82 of the flash memory 14 that contains the updated version of the operating software now contains the current version of the operating software (that is, when the RP 10 is rebooted, the indicator directs the RP 10 execute the updated operating software);

Step 184:

Send an acknowledgement to the RPCU 20 stating that the checksum is correct;

Step 186: The download procedure is complete; and

Step 188:

Reboot the RP 10 so that the RP 10 executes the updated operating software upon reboot.

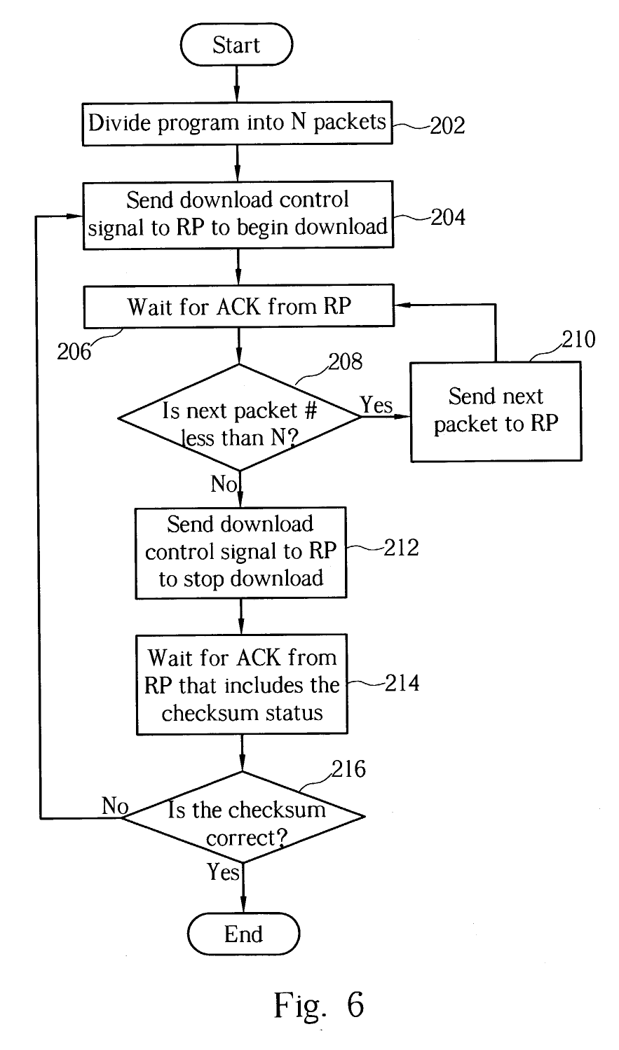

While the RP 10 is executing the procedure shown in FIG. 5A and FIG. 5B, the RPCU 20 is executing a complementary procedure. Please refer to FIG. 6. FIG. 6 contains a flow chart illustrating actions taken by the RPCU 20 to transmit updated operating software to the RP 10.

Step 202:

Divide the updated operating software into N packets, namely packet #0 through packet #N−1;

Step 204:

Send a download control signal to the RP 10 indicating that the download procedure is started;

Step 206: Wait for acknowledgement of the download control signal from the RP 10;

Step 208:

Determine if the next packet number in the sequence is less than N; if so, go to step 210; if not, all packets have been sent, go to step 212;

Step 210: Send the next packet to the RP 10; go to step 206;

Step 212:

Now that all packets have been sent to the RP 10, send a download control signal to the RP 10 indicating that the download procedure is stopped;

Step 214:

Wait for acknowledgement from the RP 10 that indicates whether the checksum calculated by the RP 10 matched the checksum sent by the RPCU 20; and

Step 216:

If the checksum calculated by the RP 10 matched the checksum sent by the RPCU 20, the download process is complete; if not, go to step 204.

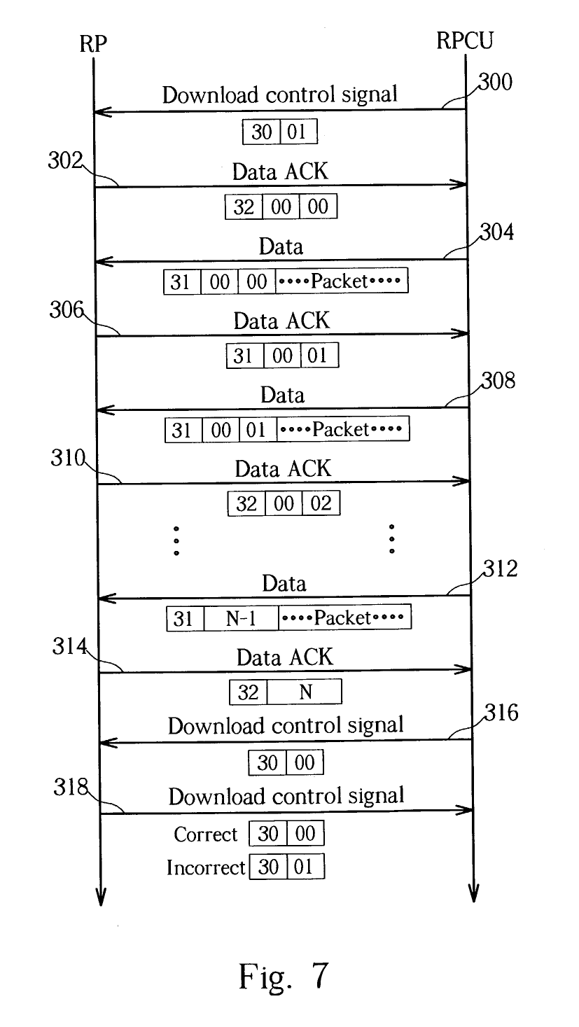

Please refer to FIG. 7 with reference to FIG. 5A, FIG. 5B, and FIG. 6. FIG. 7 is a message sequence chart illustrating communication between the RP 10 and the RPCU 20 during an update procedure. In FIG. 7, the vertical axis represents time, and time increases from top to bottom. Three types of signals are sent back and forth between the RP 10 and the RPCU 20. In FIG. 7, download control signals are shown containing two bytes, with the first byte containing a value of “30” and the second byte containing an indicator. If the RPCU 20 is sending the download control signal to the RP 10, an indicator of “01” represents that the download procedure is started, and an indicator of “00” represents that the download procedure is stopped. If the RP 10 is sending the download control signal to the RPCU 20, an indicator of “01” represents that the checksum is incorrect, and an indicator of “00” represents that the checksum is correct. Data acknowledgement signals are shown containing three bytes, with the first byte containing a value of “32” and the second and third bytes indicating which packet the RP 10 is requesting from the RPCU 20. Data packet signals are shown containing a first byte with an indicator of “31” and two bytes used for indicating the packet number in addition to the number of bytes needed for one packet.

When starting the update procedure, communication between the RP 10 and the RPCU 20 is initiated by the RPCU 20. As shown in FIG. 7, the RPCU 20 sends message 300 to the RP 10 containing a download control signal with an indicator of “01”, meaning that the download procedure is started. In response to this, the RP 10 sends message 302 to the RPCU 20 containing an acknowledgement to the download control signal, and asking for packet #0000. The RPCU 20 sends message 304 to the RP 10 containing packet #0000. Packet #0000 contains the checksum calculated by the RPCU 20, and the RP 10 stores this in RAM 12. Moving on to the next packet, the RP 10 sends message 306 to the RPCU 20 containing an acknowledgement to packet #0000, and asking for packet #0001. The RPCU 20 then sends message 308 to the RP 110 containing packet #0001. Next, the RP 10 sends message 310 to the RPCU 20 containing an acknowledgement to packet #0001, and asking for packet #0002. The process of sending the next data packet acknowledging data packets continues until packet #N−1 is reached. In message 312, the RPCU 20 sends packet #N−1 to the RP 10, which is the last packet in the download. In response to this, the RP 10 sends message 314 to the RPCU 20 containing an acknowledgement to packet #N−1, and asking for packet #N. Once the RPCU 20 receives a request for packet #N, all of the data packets have been sent. The RP 10 then calculates a checksum based on the updated operating software just received. The RPCU 20 sends message 316 to the RP 10 containing a download control signal with an indicator of “00”, meaning that the download procedure is stopped. Finally, the RP 10 sends message 318 to the RPCU 20 containing a download control signal. An indicator of “00” signifies that the checksum calculated by the RP 10 matches the checksum calculated by the RPCU 20, and an indicator of “01” means that the checksums did not match.

In a preferred embodiment of the present invention, the RP 10 and the RPCU 20 are compatible with the personal access communications system (PACS), and the RP 10 can download data from the RPCU 20 over an embedded operation channel (EOC). The use of the EOC allows data packets to be sent from the RPCU 20 to the RP 10 without using bandwidth that is used to provide service for the cellular phone network.

Compared to the prior art method of updating operating software in an RP, the present invention method eliminates the need for a technician to come out to the site of the RP and manually replace the old flash memory with a new flash memory. In addition, the system parameters of the RP such as channel and power characteristics do not have to be updated as a result of updating the operating software in the RP. By having two program code areas for storing two versions of the operating software, an updated version can be downloaded while the RP executes the old version of the operating software. This means that no disruption of service is necessary while updating the operating software of the RP. Furthermore, since the operating software is updated remotely, all RPs connected to an RPCU can be updated conveniently and quickly. Not only can the operating software be remotely updated, but a user coordinating the update can also be sure that the process of downloading the updated operating software was successful. Since each packet sent by the RPCU is acknowledged by the RP, and since checksums calculated by the RPCU and the RP are compared to each other, the user can have a guarantee that the download was successful.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of remotely sending updated radio port software from a radio port control unit (RPCU) to a radio port (RP) and storing the RP software in a memory of the RP, the memory comprising:
a first program code area for storing a first version of the RP software;
a second program code area for storing a second version of the RP software; and
an internal parameter area containing an indicator for indicating which of the first and second program code areas stores RP software to be executed by the RP;
the method comprising steps:
reading the indicator in the internal parameter area to determine which of the first or second program code areas is used for storing a current version of the RP software;
running the current version of the RP software from either the first or second program code areas of the memory;
storing an updated version of the RP software in the first or second program area that is not used for storing the current version of the RP software; and
changing the indicator in the internal parameter area to indicate which of the first or second program code areas is used for storing the updated version of the RP software.

2. The method of claim 1 further comprising rebooting the RP and executing the updated version of the RP software after rebooting.

3. The method of claim 1 further comprising the RP calculating a first checksum of the updated version of the RP software and comparing the first checksum with a second checksum calculated by the RPCU for verifying the accuracy of the updated version of the RP software.

4. The method of claim 1 wherein the memory is a flash memory.

5. The method of claim 1 wherein the RP and the RPCU are compatible with the personal access communications system (PACS).

6. The method of claim 1 wherein the RPCU transmits data to the RP over an embedded operation channel (EOC).

7. A personal access communications system (PACS) for implementing the method of claim 1.

8. A method of remotely sending updated radio port software from a radio port control unit (RPCU) to a radio port (RP), the method comprising steps:
(a) the RPCU dividing the updated RP software into a plurality of packets;
(b) the RPCU sending a download control signal to the RP indicating that the updated RP software is to be sent from the RPCU to the RP;
(c) the RP sending an acknowledgment signal to the RPCU indicating that the RP is ready to receive a first packet of the updated RP software;
(d) the RPCU sending the first packet to the RP, the first packet containing a first checksum provided for verifying the contents of the updated RP software;
(e) the RP receiving the first packet and storing the first checksum in a first memory;
(f) the RP sending an acknowledgment signal to the RPCU indicating that the RP is ready to receive another packet of the updated RP software;
(g) the RPCU sending a next packet to the RP;
(h) the RP receiving the next packet;
(i) the RP sending an acknowledgment signal to the RPCU indicating that the RP is ready to receive another packet of the updated RP software;
(j) repeating steps (g) through (i) until the RPCU has sent all packets to the RP;
(k) the RP calculating a second checksum of the updated RP software received by the RP and determining if the first checksum has a same value as the second checksum;
(l) the RP storing the updated RP software in a second memory if the first and second checksums are equal; and
(m) the RP sending an acknowledgment signal to the RPCU indicating that the RP has correctly received the updated RP software.

9. The method of claim 8 wherein the second memory comprises:
a first program code area for storing a first version of RP software;
a second program code area for storing a second version of the RP software; and
an internal parameter area containing an indicator for indicating which of the first and second program code areas stores RP software to be executed by the RP;
the method further comprising:
using the indicator in the internal parameter area to indicate which of the first or second program code areas is used for storing a current version of the RP software; and
running the current version of the RP software from either the first or second program code areas of the second memory.

10. The method of claim 9 wherein in step (1) if the first and second checksums are equal, step (I) further comprises reading the indicator in the internal parameter area to determine which of the first or second program code areas is used for storing the current version of the RP software, storing the updated RP software in the first or second program area that is not used for storing the current version of the RP software, and changing the indicator in the internal parameter area to indicate which of the first or second program code areas is used for storing the updated RP software.

11. The method of claim 9 wherein in step (1) if the first and second checksums are not equal, step (I) further comprises the RP sending a request signal to the RPCU to request that the RPCU resend the updated RP software to the RP.

12. The method of claim 10 further comprising step:
(n) rebooting the RP and executing the updated RP software after rebooting.

13. The method of claim 8 further comprising if the RP does not receive an expected packet of the updated RP software, the RP sending a request signal to the RPCU to request that the RPCU resend the expected packet of the updated RP software to the RP.

14. The method of claim 8 wherein the first memory is a random access memory (RAM).

15. The method of claim 8 wherein the second memory is a flash memory.

16. The method of claim 8 wherein the RP and the RPCU are compatible with the personal access communications system (PACS).

17. The method of claim 8 wherein the RPCU transmits data to the RP over an embedded operation channel (EOC).

18. A personal access communications system (PACS) for implementing the method of claim 8.
